(19) United States
(12) Patent Application Publication
(10) Pub. No.: US 2011/0293507 A1
(43) Pub. Date: Dec. 1, 2011

(54) PROCESS OF MAKING NANO-SCALE INTEGRATED TITANIA PARTICLES FOR LITHIUM BATTERY ELECTRODE APPLICATIONS

(76) Inventors: Damien Dambournet, Chicago, IL (US); Ilias Belharouak, Bolingbrook, IL (US); Khalil Amine, Oakbrook, IL (US)

(21) Appl. No.: 13/100,602

(22) Filed: May 4, 2011

Related U.S. Application Data
(60) Provisional application No. 61/348,378, filed on May 26, 2010.

(51) Int. Cl. C01G 23/047; C07F 7/28; B82Y 40/00

(52) U.S. Cl. 423/598; 556/55; 423/610; 977/896

(57) ABSTRACT

A process includes reacting a titanium compound with an oxalate compound in an acidic medium to form a titanium oxalate complex, where the titanium oxalate complex includes primary and secondary particles. The primary titanium oxalate complex particles may be from about 1 nm to about 200 nm; and the secondary titanium oxalate complex particles may be from about 0.5 μm to 50 μm. The titanium oxalate complex may be sintered to prepare a titania-based compound. The titania-based compounds may be used to fabricate electrodes for electrochemical cells.

### CROSS-REFERENCE TO RELATED APPLICATIONS

This application claims the benefit of U.S. Provisional Patent Application No. 61/348,378, filed on May 26, 2010, the entire disclosure of which is incorporated herein by reference for any and all purposes.

### GOVERNMENT INTERESTS

This invention was made with Government support under Contract No. EE-2G-49845-00-107 awarded by the Department of Energy. The Government has certain rights in this invention.

### FIELD

The technology is generally related to electrochemical devices and titanium-based compounds for use in such devices.

### BACKGROUND

Titanium oxide, i.e. titania or TiO₂, materials have a rich, structural diversity through the existence of several structural forms, i.e. polymorphs: anatase, brookite, and rutile. Anatase is of the tetragonal phase, with a I4₁/amd space group; brookite is an orthorhombic phase with a Pbca space group; and rutile is a tetragonal phase with a P4₂/mnm space group. While extended studies have been devoted to the synthesis and physico-chemical characterizations of the anatase and rutile forms of TiO₂, the mestastability of the brookite polymorph has prevented such research activities.

From an electrochemical standpoint, titania is a lithium insertion material with the capacity of integrating one lithium ion per unit formula due to the reversible reduction/oxidation of Ti⁴⁺ to Ti³⁺. The electrochemical behavior of the anatase and rutile forms, widely investigated in the literature, exhibits a two phase-order transition upon lithiation while due to larger structural voids, the brookite form keeps its original structure. In general, to behave as suitable lithium-host materials, these titanium oxide compounds need to be prepared as nanoparticles. However, nano-particle production of the titania leads to severe practical limitations that include (i) low volumetric energy density (low packing density), and (ii) difficulties in making the electrode, due to the tendency of the nanoparticles to agglomerate. We are not aware of any industrial methods for the production of the brookite form.

### SUMMARY

Processes are provided for the preparation of titanium oxalate complexes that may be used as precursors to titania-based compounds for use in the electrodes of electrochemical devices. The titanium oxalate complexes are formed by the reaction of a titanium compound with an oxalate compound in an acidic medium. According to some embodiments, the titanium oxalate complexes precipitate from the medium as nano-scale primary particles that agglomerate into nano- to micro-scale secondary particles. Upon sintering of the titanium oxalate complex, the titania-based compounds are formed, and retain the primary-secondary structure of the oxalate complexes. The titania-based compounds may be used in the preparation of electrodes for use in electrochemical cells, batteries, and super-capacitors.

Accordingly, in one aspect, a process includes reacting a titanium compound with an oxalate compound in an acidic medium to form a titanium oxalate complex; where the titanium oxalate complex includes primary and secondary particles. In one embodiment, the primary titanium oxalate complex particles have a diameter from about 1 nm to about 200 nm; and the secondary titanium oxalate complex particles have a diameter from about 0.5 μm to about 50 μm. In one embodiment, the titanium oxalate compound is represented by the general formula (Ti₂ₓAₐB_{b}C_{c}D_{d}EₑF_{f})O₃(H₂O)₂(C₂O₄), where A is a monovalent cation; B is divalent cation; C is a trivalent cation; D is a tetravalent cation tetravalent; E is a heptavalent cation; F is a hexavalent cation; 0<x≦1; 0≦b<2; 0≦c<2; 0≦d<2; 0≦e<2; 0≦f<2. In another embodiment, the titanium oxalate complex is represented by the formula Ti₂O₃(H₂O)₂(C₂O₄).H₂O.

In another aspect, the process may also include sintering the titanium oxalate complex to form a titania-based compound; where the titania-based compound includes primary and secondary particles. In one embodiment, the sintering includes heating the titanium oxalate complex to a temperature and for a time sufficient to remove at least some of the carbon and water. In another embodiment, the titania-based compound is brookite titania.

In another aspect, an electrode includes any of the titania-based compounds prepared by the above processes.

### BRIEF DESCRIPTION OF THE DRAWINGS

FIG. 1 is an SEM (Scanning Electron Microscopy) image of a titanium oxalate precursor prepared by thermolysis (90° C.) for 4 h of an aqueous solution of titanium oxysulfate and lithium oxalate, according to Example 1.

FIG. 2 is an x-ray diffraction (XRD) powder pattern of a titanium oxalate precursor with the targeted chemical formula [Ti₂O₃(H₂O)₂](C₂O₄).H₂O prepared by the thermolysis (90° C.) for 4 h of an aqueous solution of titanium oxysulfate in the presence of an oxalate precursor (Li₂C₂O₄) with a molar ratio [C₂O₄²⁻]/[Ti⁴⁺]=1, according to Example 2.

FIG. 3 is an infrared spectrum of a [Ti₂O₃(H₂O)₂](C₂O₄).H₂O precursor, according to Example 2.

FIGS. 4A and 4B are SEM images of a titanium oxalate precursors prepared from (A) lithium oxalate, and (B) sodium oxalate, according to Example 3.

FIG. 5A is a thermogravimetric analysis (TGA) graph of [Ti₂O₃(H₂O)₂](C₂O₄).H₂O precursor, heated in air, and FIG. 5B is a differential scanning calorimetric curve that shows a single event, both according to Example 4.

FIG. 6 is an ex-situ XRD pattern of a titanium oxalate precursor [Ti₂O₃(H₂O)₂](C₂O₄).H₂O annealed at different temperatures, according to Example 4.

FIG. 7 shows an SEM image of the titanium oxalate after an annealing treatment at 300° C. for 4 h under an air atmosphere, according to Example 4.

FIG. 8 shows adsorption isothermal graphs of TiO₂-brookite prepared by thermal decomposition of Ti₂O₃(H₂O)₂(C₂O₄).H₂O at 300° C., according to Example 4.

FIGS. 9A and 9B are SEM images of a titanium oxalate precursor prepared by thermolysis at 90° C. (A) and 70° C. (B), according to Example 5.

FIG. 10 is a voltage profile vs. capacity of a Li/TiO₂ cell cycled between 1 and 3V at C/20, according to Example 6.

FIGS. 11A and 11B is an XRD pattern of Li₄Ti₅O₁₂ (A) and SrLi₂Ti₆O₁₄ (B) prepared by using high surface area TiO₂-brookite as a titanium source, according to Example 7.

### DETAILED DESCRIPTION

A process of tailoring the morphology of the titanium oxalate compounds is provided. Such compounds are produced as nano-scale, high packing density particles. The titanium oxalate complex may then be used to prepare titania-based compound of a desired morphology. The prepared titania may be as a nano-scale powder, and may be tailored to have high surface area and high packing density. The titania may be used to further prepare lithiated titania and complex titania-based oxide compounds through either solid-state reactions or impregnation methods using the defined precursors. The resulting solids also exhibit a nano-structure with high packing density. Such compounds may then be used as positive and negative electrodes in lithium and sodium batteries, super-capacitors, and solar cells.

In one aspect, a process is provided for preparing titanium oxalate complexes by co-precipitation reactions and/or hydrothermal conditions. The design and control of the particle architecture, i.e. morphology can be achieved via etching and/or dissolution reactions. The processes also provide for the further preparation of titania-based compounds (titania is TiO₂) from the titanium oxalate complexes. The titania may be produced as any of the brookite, anatase, or rutile polymorphs. In one embodiment, the brookite polymorph is produced. In other embodiments, lithium titanate and complex titanate oxides are also provided, each having a unique morphology that includes nano-domains of primary particles embedded in micron-sized secondary particles leading to high surface area and high packing density. In general, co-precipitation reactions involve nucleation and growth, etching and dissolution reactions under conditions wherein temperature, pH of media, and concentration of reactants can favor one product over another.

The processes provide for the preparation of dense, titanium oxalate complexes that exhibit a variety of morphologies. The dense, titanium oxalate complexes include small primary particles that agglomerate into larger secondary particles. The agglomeration leads to the secondary particles having flower, eggshell, needle, polygonal, or spherical morphologies. The secondary particles size is from about 0.5 μm to about 50 μm, and the mechanical integrity is not compromised. In one embodiment, the second particle size is from about 1 μm to about 30 μm. The primary particle size ranges from about 5 nm to about 200 nm. In some embodiments, the primary particle size is from about 5 nm to about 50 nm.

The process includes reacting a titanium compound with an oxalate compound in an acidic medium to form the titanium oxalate complex which a morphology that includes both primary and secondary particles. In some embodiments, the process also includes filtering of the titanium oxalate complex, washing, and drying.

In some embodiments, the titanium compound is a reactive titanium compound. Suitable titanium compounds include, but are not limited to, TiF₄, TiF₃, TiCl₄, TiCl₃, TiBr₄, TiI₄, Ti₂O₃, TiOF₂, TiOCl₂, TiOSO₄, Ti(OCH₂CH₂CH₃)₄, Ti(OCH(CH₃)₂)₄, Ti(OCH₃)₄, Ti(OCH₂CH₃)₄, Ti(O(CH₂)₃CH₃)₄, Ti(OC(CH₃)₄)₄, Ti(C₂O₄)₂, or K₂TiO(C₂O₄)₂. In some embodiments, a concentration of the titanium compound in the acidic medium is from about 0.01 M to about 5 M. In another embodiment, the concentration of the titanium compound in the acidic medium is from about 0.5 M to about 1.2 M.

In some embodiments, the oxalate compound is a reactive oxalate compound. Suitable oxalate compounds include, but are not limited to, Li₂[C₂O₄], C₂H₂O₄, Na₂[C₂O₄], K₂[C₂O₄], [NH₄]₂[C₂O₄], [NH₄][C₂O₃(OH)], and transition metal oxalates.

In some embodiments, the acidic medium includes a mineral or organic acid. Suitable acids include, but are not limited to, oxalic acid, sulfuric acid, nitric acid, hydrochloric acid, perchloric acid, and hydrofluoric acid.

In some embodiments of the process, the prepared titanium oxalate complexes prepared have the formula Ti₂O₃(H₂O)₂(C₂O₄).H₂O, Ti₂O₃(H₂O)₂(C₂O₄), or Ti₂O₃(C₂O₄).

In some embodiments, the process also includes controlling the temperature of the reacting step to control the morphology of the titanium oxalate complex and to drive the reaction to completion. For example, the temperature of the acidic medium during the reacting step is from 25° C. to 200° C. In one embodiment, the temperature of the acidic medium during the reacting step is from 60° C. to 120° C. In one illustrative example, where the temperature of the reaction is about 90° C., an eggshell morphology of the titanium oxalate is obtained. This eggshell morphology is then maintained when the titanium oxalate is converted to the brookite material.

The pH of the acidic medium during the process also has an impact on the morphology of the obtained titanium oxalate complex. In some embodiments, the pH is from about 0.1 to 7, or from about 0.1 to abut 4, in other embodiments. In yet other embodiments, the pH is from about 0.1 to about 2. In one illustrative example, where the pH of the reaction is about 0.1 to about 2, an eggshell morphology of the titanium oxalate is obtained. This eggshell morphology is then maintained when the titanium oxalate is converted to the brookite material.

The reaction may also be stirred during the process. For example, the stirring speed may be from 100 rpm to 5000 rpm. In some embodiments, the stirring speed is about 500 rpm to about 1500 rpm.

As noted, the processes may also include collecting the titanium oxalate complex via filtration, washing of the complex, and drying of the complex. The washing may be accomplished with solvents such as water, methanol, ethanol, n-propanol, iso-propanol, or acetone. The drying may be accomplished at room temperature or elevated temperature, with or without the aid of a vacuum. In some embodiments, the titanium oxalate complex is dried at a temperature of from about 25° C. to about 120° C. under a vacuum.

In some embodiments, the reacting step includes co-precipitation after an acid-base reaction. The acid-base reaction includes mixing an acidic solution containing a titanium a reactive titanium compound with a basic solution containing a reactive oxalate compound. In such embodiments, the reacting also includes adding a precipitating agent to the mixture. Suitable precipitating agents include, but are not limited to NaOH, LiOH, NH₄OH, Li₂[C₂O₄], H₂[C₂O₄], Na₂[C₂O₄], K₂[C₂O₄], [NH₄]₂[C₂O₄], and [NH₄][C₂O₃(OH)]. In such embodiments, the concentration of the titanium compound in the acid medium and the concentration of the oxalate compound in the basic compound ranges from about 0.05 M to about 5 M. In other embodiments, the concentration of the titanium compound in the acid medium and the concentration of the oxalate compound in the basic compound are from about 0.1 M to about 3M. During co-precipitation, the acidic medium is kept at a constant temperature from about 25° C. to about 100° C. The acid medium may also be stirred during co-precipitation. In such embodiment, the stirring speed of the solution may be fixed or it may vary from about 50 rpm to about 5000 rpm. In some embodiments, the co-precipitation method is performed using a continuous stirred tank reactor process.

In some embodiments, the reacting step includes a hydrothermal reaction. Hydrothermal reactions include precipitation of the titanium oxalate complex in a closed vessel at a temperature of 60° C., or greater. In some embodiments, the temperature is from 60° C. to 500° C. In other embodiments, the temperature is from 80° C. to 500° C. The secondary bulk particles produced by such hydrothermal reactions have dimensions from about 0.5 μm to about 30 μm. The concentration of the titanium compound and the oxalate compound ranges from about 0.05 M to about 5 M. In one embodiment, the concentration of the titanium compound and the oxalate compound is about 0.1 M to about 0.2 M. In another embodiment, the concentration of the titanium compound and the oxalate compound is about 2 M to about 3 M. The hydrothermal reaction is performed in an autoclave that is kept at a constant temperature from about 25° C. to about 300° C., for from 1 h to several days.

As described, the particles that are formed may exhibit a wide variety of morphologies. For example, the titanium oxalate complexes may form as nano-sized powders that under high magnification appear to have an eggshell, flower, needle, polygonal, or spherical appearance. As used herein, the term eggshell refers to a shape that is generally oval to circular and having a generally smooth appearance but which may have some minor roughness, like the shell of an egg. As used herein, the term flower refers to shapes that are similar to those of eggshell shapes, however, the surface is much rougher and coarser, such that it appears to be like that of a flower, such as a carnation. As used herein, the term needle refers to shapes that are elongated and like a needle in appearance. As used herein, the term polygonal refers to a shape that has 4 or more faceted faces such that it forms a polygon. As used herein, spherical refers to a generally round appearance. In some embodiments, the diameter of the primary titanium oxalate complex particles are from about 1 nm to about 200 nm; and the secondary titanium oxalate complex particles are from about 0.5 μm to about 50 μm.

As noted above, the processes also provide for the further preparation of titania-based compounds from the titanium oxalate complexes. Thus, in some embodiments, the process may further include sintering the titanium oxalate complex to form the titania-based compound. Such titania-based compounds retain the morphology of the titanium oxalate complex from which they are made, such that the titania-based compound includes primary and secondary titania particles. In some embodiments, the primary titania-based compound particles are from about 1 nm to about 200 nm; and the secondary titania-based compound particles are from about 0.5 μm to about 50 μm. The titania-based compound particles also may form as nano-sized powders that under high magnification appear to have an eggshell, flower, needle, polygonal, or spherical appearance.

In some embodiments, the sintering includes heating the titanium oxalate complex to a temperature, and for a time, sufficient to remove at least some of the carbon and water. In some embodiments, the sintering may include heating under an oxidizing atmosphere. Suitable oxidizing atmospheres may include, but are limited to those containing oxygen, NO, NO₂, or mixture thereof. In other embodiments, the sintering includes heating under a reducing atmosphere. Suitable reducing atmospheres may include, but are not limited to, those containing hydrogen, alkanes, water, and/or carbon monoxide.

The sintering temperature may impact the morphology of the obtained titania-based compounds. Thus, in some embodiments, the sintering temperature is from about 100° C. to about 1000° C. In another embodiment, the sintering temperature is from about 200° C. to about 600° C. The use of titanium oxalate allows for the production of the TiO₂ brookite when low temperatures are used in the hydrothermal reaction. For example, where the temperature is from about 300° C. to about 600° C., the brookite is formed from the titanium oxalate. Above 600° C., the brookite is then transformed into the rutile phase.

The sintering time may impact the morphology of the obtained titania-based compounds. The sintering time is determined by the release of water and CO₂ from the titanium oxalate and is held for completion. Thus, in some embodiments, the sintering time is from 1 hour to about one week. In some embodiments, the sintering time is from 1 hour to 3 days. In other embodiments, the sintering time is from 1 hour to 12 hours.

The titania-based compounds may also include other components such as carbon or other cations. In some embodiments, the titania-based compound includes residual carbon from the sintering of the titanium oxalate complex. In some embodiments, the titanium oxalate Ti₂O₃(H₂O)₂(C₂O₄) may include other cations and have the general formula (Ti₂ₓAₐB_{b}C_{c}D_{d}EₑF_{f})O₃(H₂O)₂(C₂O₄), where A is a monovalent cation; B is divalent cation; C is a trivalent cation; D is a tetravalent cation tetravalent; E is a heptavalent cation; F is a hexavalent cation; 0<x≦1; 0≦b<2; 0≦c<2; 0≦d<2; 0≦e<2; 0≦f<2. In other embodiments, the titania based compound may have the general formula (TiₓAₐB_{b}C_{c}D_{d}EₑF_{f})O_{2-q}G_{q}, where G is F or S. Illustrative monovalent cations “A” include, but are not limited to, one or more of Li⁺, Na⁺, K⁺, Rh⁺, and Cs⁺. Illustrative divalent cations “B” include, but are not limited to, one or more of Mg²⁺, Ca²⁺, Sr²⁺, Ba²⁺, and Zn²⁺. Illustrative trivalent cations “C” include, but are not limited to, one or more of Cr³⁺, V³⁺, Fe³⁺, Y³⁺, and Al³⁺. Illustrative tetravalent cations “D” include, but are not limited to, one or more of Zr⁴⁺, V⁴⁺, Mn⁴⁺, and Sn⁴⁺. Illustrative pentavalent cations “E” include, but are not limited to, one or more of Nb⁵⁺ and Vs⁵⁺. Illustrative hexavalent cations “F” include, but are not limited to, one or more of Mo⁶⁺ and W⁶⁺.

In some embodiments, the titania-based compound, is titanium oxalate, titanium oxide, lithium titanium oxide, or complex titanium-based oxides. For example, in some embodiments, the titania-based compound includes lithium. In such embodiments, the titania-based compound is Li₂TiO₃, LiTi₂O₄, Li₄Ti₅O₁₂, SrLi₂Ti₆O₁₄, BaLi₂Ti₆O₁₄, or Na₂Li₂Ti₆O₁₄. The titania-based compounds may be further subjected to a coating and/or a doping process. Typically, the coating process consists of a deposition of a conductive phase that is, but is not limited to, carbon, titanium nitride, tungsten, or other transition metals on the surface of the secondary particles. Typically, the doping process is performed during the synthesis of the titanium oxalate complex, and may include the incorporation of metals such as copper, tin, vanadium, iron, niobium, or zirconium to the reaction.

In another aspect, the titanium oxalate complexes are used to prepare lithiated titanates that may be used to fabricate electrodes and electrochemical cells. Such lithiated titanates provide for electrodes having a high energy density and high power.

As noted above, the processes provided are for the preparation of dense compounds and complexes. One measure of the density is the packing density. In some embodiments, the titania-based compound has a packing density from about 0.5 g/cm³ to about 3.0 g/cm³. In another embodiment, the titania-based compound has a packing density from about 0.8 g/cm³ to about 2.0 g/cm³. As used herein, the tap density is measured according to ASTM B527 (metallic powders) or ISO 787-11 (pigments). This compares to commercial nanosize TiO₂ which has a packing density on the order of 0.05 g/cm³.

The surface area of the active materials in an electrode of an electrochemical cell, directly impact the amount of current that may be generated and the amount of power that may be passed through the cell. The titania-based compounds described above have high surface areas. In some embodiments, a specific surface area of the titania-based compound is from about 1 m²/g to about 500 m²/g. In other embodiments, a specific surface area of the titania-based compound is from about 100 m²/g to about 400 m²/g.

The titania-based compounds, lithiated titania, and titanates produced by the above methods may be incorporated into electrodes of electrochemical cells, batteries, and super-capacitors.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology, thus generally described, will be understood more readily by reference to the following examples, which are provided by way of illustration and are not intended to be limiting.

### EXAMPLES

### Example 1

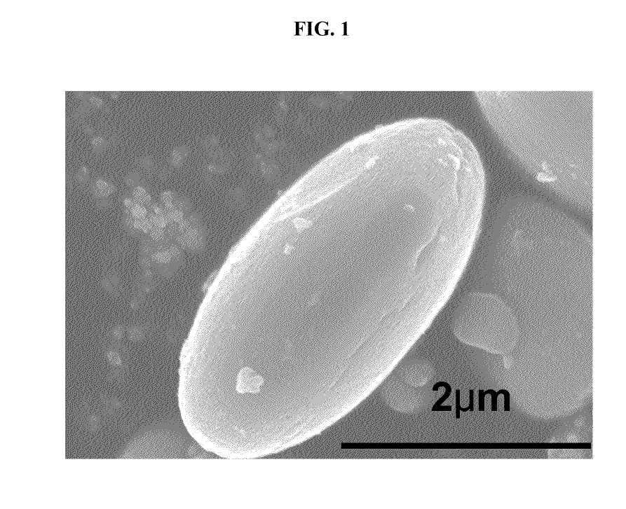

A titanium oxalate compound Ti₂O₃(H₂O)₂(C₂O₄).H₂O was prepared by precipitation from a 0.9 M acidic solution of titanium oxysulfate and a 0.9M solution of lithium oxalate dissolved in distilled water. The precipitation was performed at a pH of about 0.1 and at 90° C. for 4 h. An SEM (FIG. 1) image revealed that the precursor has an eggshell-like morphology with an average secondary particle size of approximately 2 μm. The compound is also dense, with a packing density of 1.2 g/cm³.

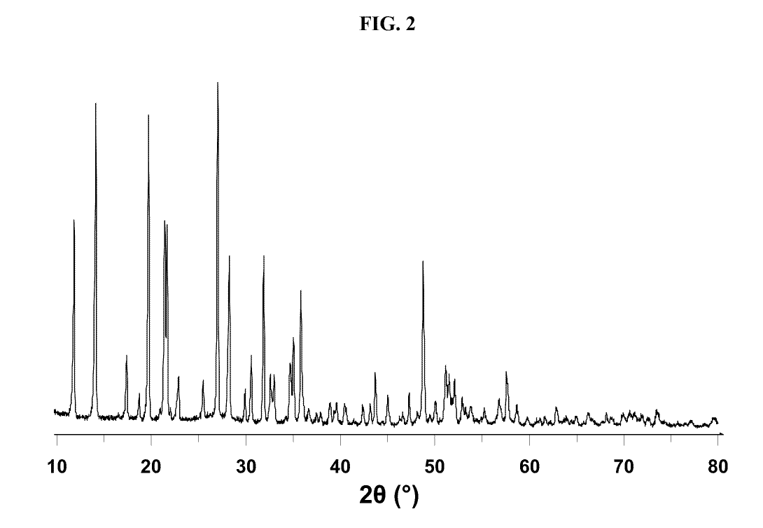

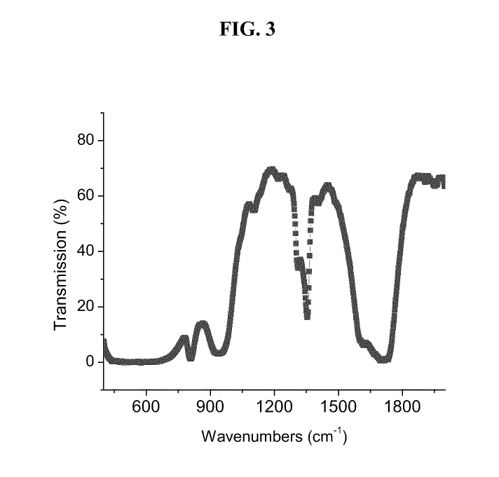

### Example 2

[Ti₂O₃(H₂O)₂](C₂O₄).H₂O was prepared from a 0.9M acidic solution of titanium oxysulfate and a 0.9M solution of lithium oxalate dissolved in distilled water, at a pH of about 0.1 FIG. 2 shows an X-ray diffraction powder pattern of the prepared titanium oxalate compound, [Ti₂O₃(H₂O)₂](C₂O₄).H₂O. All diffraction lines are indexed in the orthorhombic Cmca space group, and no secondary phases were detected. FIG. 3 shows the IR spectrum of the [Ti₂O₃(H₂O)₂](C₂O₄).H₂O. The IR spectrum confirmed the occurrence of water and oxalate moieties in the material through the absorptions from 1600 cm⁻¹ to 1800 cm⁻¹.

### Example 3

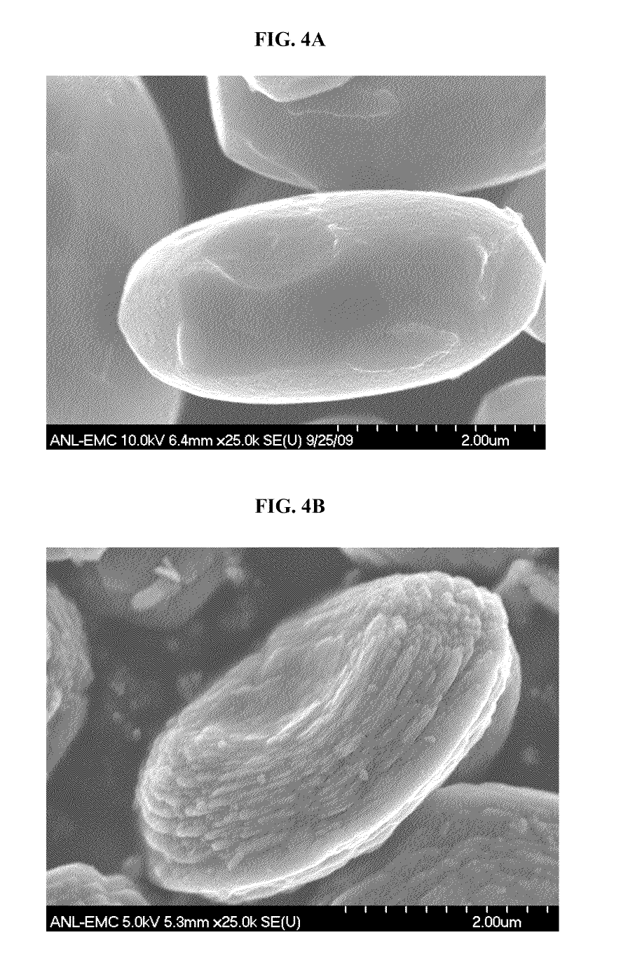

Controlling the size and morphology of the oxalate compounds. FIGS. 4A and 4B are SEM images of titanium oxalate compounds that have been identically prepared, except that the oxalate reactant was lithium oxalate in FIG. 4A and the oxalate reactant was sodium oxalate in FIG. 4B. As shown, the lithium oxalate provides for a smooth, oval, eggshell-like morphology, while the sodium oxalate provides for a rougher, oval, flowerlike-morphology. In some aspects, the tailoring of the morphology is performed through an etching mechanism leading to a partial dissolution of the particle and thus tailoring of the morphology of the particles. Such an etching can be isotropic (FIG. 4A) and/or anisotropic (FIG. 4B).

### Example 4

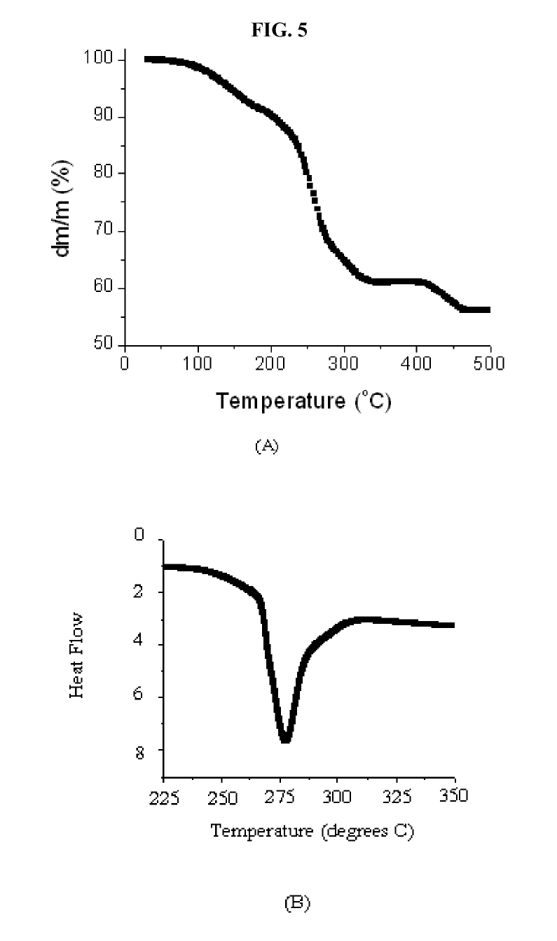

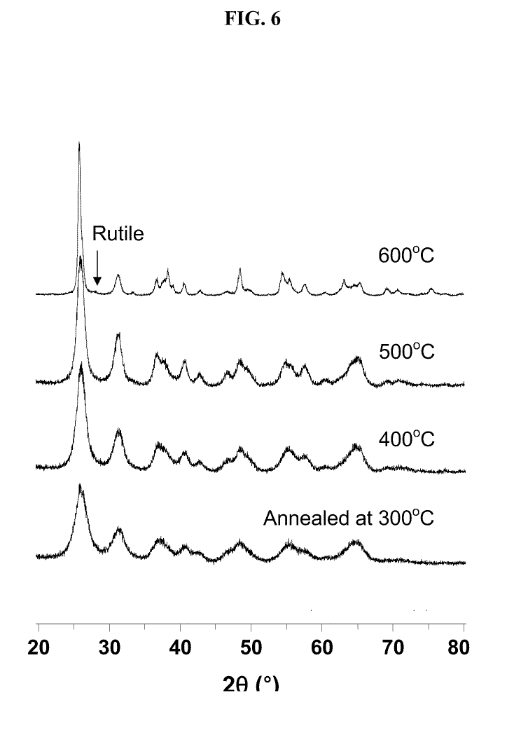

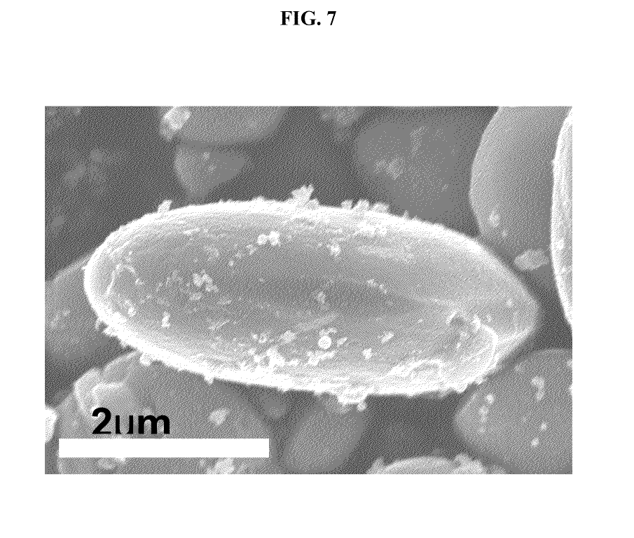

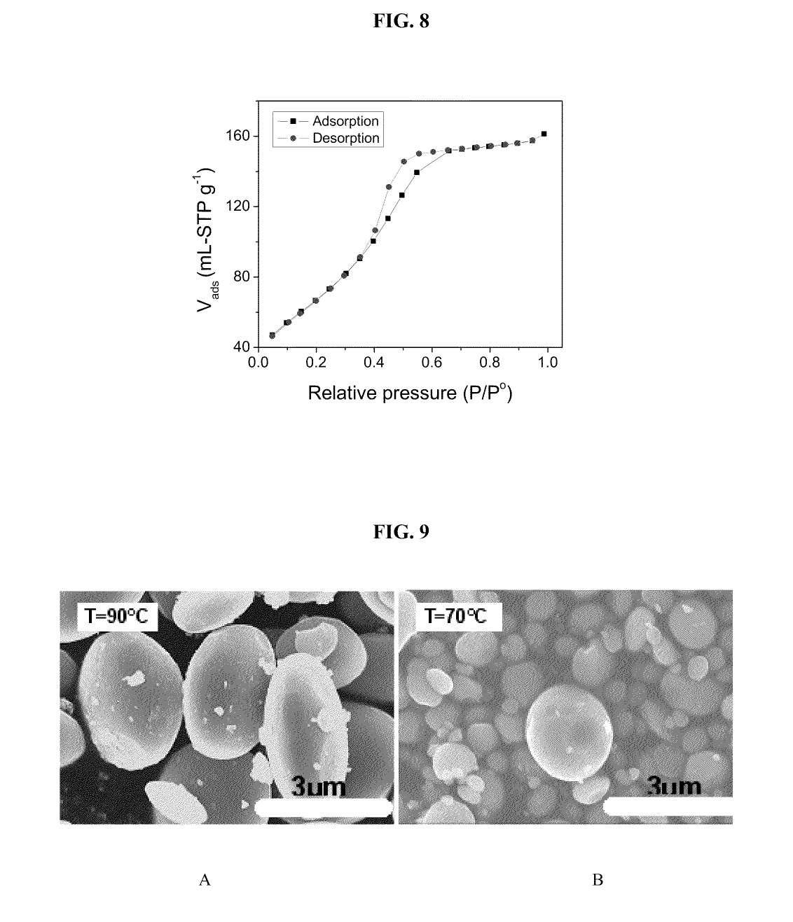

A titanium oxalate compound, [Ti₂O₃(H₂O)₂](C₂O₄).H₂O, was used to prepare titania based-oxides including its lithium derivatives and complex titanium oxide compounds. FIG. 5A shows the thermogravimetric analysis (TGA) of the titanium oxalate compound performed under air, at a rate of 10° C./min, from room temperature to 800° C. The TGA curve shows that the decomposition of the titanium oxalate is completed at around 450° C. The differential scanning calorimetric curve (FIG. 5B) shows one main event occurring between 250° C. and 300° C. FIG. 6 shows the ex-situ x-ray diffraction (XRD) powder patterns obtained after various annealing treatments of the titanium oxalate performed at different temperatures with a heating ramp of 10° C./min for 4 h. FIG. 5. indicates that the titanium oxalate is converted into TiO₂ with the brookite structure at about 300° C., while at 600° C. the rutile phase starts to appear in the x-ray diagram. FIG. 7 shows an SEM image of the titanium oxalate after an annealing treatment at 300° C. As observed from FIG. 7, the as-prepared TiO₂ brookite retained the morphology of the oxalate precursor that is, in the present case, a dense, eggshell particle providing a high packing density. Moreover, the curve in FIG. 8 is typical of a type IV isotherm, which is consistent with meso-porous TiO₂ brookite. The surface area calculated by the BET method was shown to be very high, i.e. up to 400 m²/g, which can only be explained by the existence of significant porosity created at the level of the eggshell micron-size particles. The meso-pore size was centered at 3.4 nm, and the total porous volume was 0.25 ml/g. While, such a porosity provides a higher surface contact between the material and the electrolyte that will enhance the electrochemical activity, the rounded-type morphology is suitable for the electrode coating process.

### Example 5

The size of the dense, eggshell nano-sized titanium oxalate compound can easily be monitored by tuning the synthesis conditions. FIGS. 9A and 9B are two SEM images of the titanium oxalate compound that have been prepared at two different temperatures, i.e. T=70° C. and 90° C. From FIG. 9, it can be shown that the decreasing the temperature leads to a decrease of the secondary particles from 3 μm to 1 μm providing higher surface area.

### Example 6

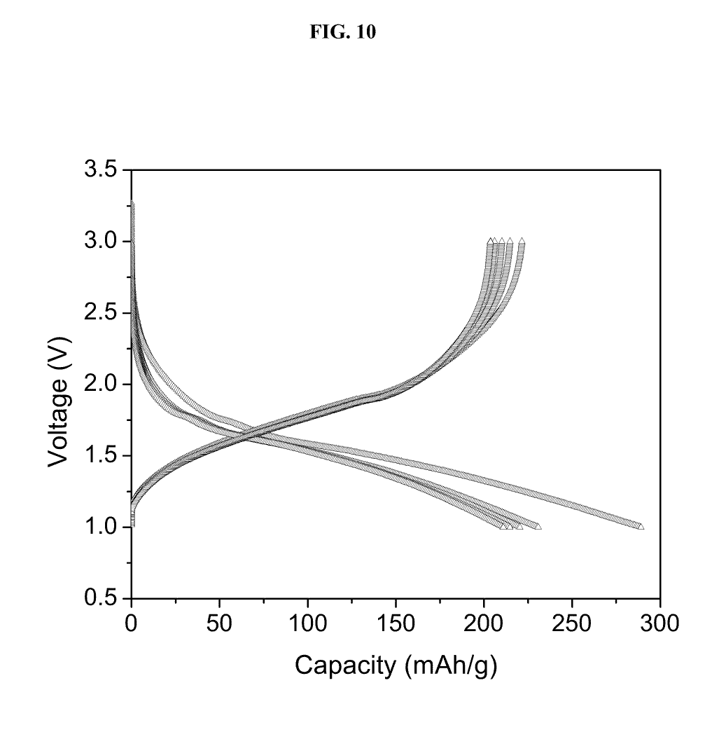

TiO₂-brookite active material, prepared by sintering of [Ti₂O₃(H₂O)₂](C₂O₄).H₂O, tested in a Li/TiO₂ cell. The electrochemical cell was prepared from a positive electrode, a negative electrode, and a non-aqueous electrolyte. The positive electrode included 80 wt % TiO₂-brookite powder, 10 wt % carbon, and 10 wt % PVDF binder coated on a copper foil. The negative electrode was metallic lithium. The non-aqueous electrolyte was 1 M LiPF₆ in a 3:7 mixture of ethylene carbonate (EC) and ethyl methyl carbonate (EMC) solvents. FIG. 10 shows the discharge and charge processes of the Li/TiO₂ cell performed at C/20. The cell was cycled between 1V and 3V. The first discharge capacity was 281 mAh/g while further charge and discharge provided around 210 mAh/g.

### Example 7

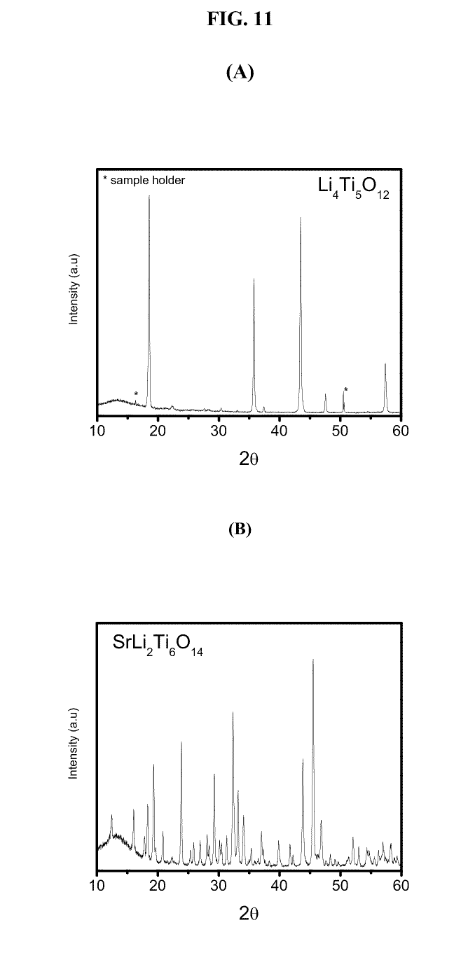

The high surface area TiO₂-brookite can be further used for the synthesis of lithium-based titanate or complex titanium-based oxide materials. FIG. 11 shows the XRD powder pattern of Li₄Ti₅O₁₂ and SrLi₂Ti₆O₁₄ prepared by using high surface area TiO₂ brookite as a titanium precursor.

The use of the terms “a” and “an” and “the” and similar referents in the context of describing the elements (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Additionally the phrase “consisting essentially of” will be understood to include those elements specifically recited and those additional elements that do not materially affect the basic and novel characteristics of the claimed invention. The phrase “consisting of” excludes any element not specifically specified.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A process comprising:
reacting a titanium compound with an oxalate compound in an acidic medium to form a titanium oxalate complex;
wherein:
the titanium oxalate complex comprises primary and secondary particles.

2. The process of claim 1, wherein the primary titanium oxalate complex particles have a diameter from about 1 nm to about 200 nm; and the secondary titanium oxalate complex particles have a diameter from about 0.5 μm to about 50 μm.

3. The process of claim 1, wherein titanium compound comprises TiF₄, TiF₃, TiCl₄, TiCl₃, Ti₂O₃, TiBr₄, TiI₄, TiOF₂, TiOCl₂, TiOSO₄, Ti(OCH₂CH₂CH₃)₄, Ti(OCH(CH₃)₂)₄, Ti(OCH₃)₄, Ti(OCH₂CH₃)₄, Ti(O(CH₂)₃CH₃)₄, Ti(OC(CH₃)₄)₄, Ti(C₂O₄)₂, or K₂TiO(C₂O₄)₂.

4. The process of claim 1, wherein the oxalate compound comprises Li₂[C₂O₄], LiH[C₂O₄], Na₂[C₂O₄], K₂[C₂O₄], [NH₄]₂[C₂O₄], [NH₄][C₂O₃(OH)], or a transition metal oxalate.

5. The process of claim 1, wherein the acidic medium comprises sulfuric acid, nitric acid, hydrochloric acid, perchloric acid, or hydrofluoric acid.

6. The process of claim 1, wherein the titanium oxalate complex is represented by the formula Ti₂O₃(H₂O)₂(C₂O₄).H₂O.

7. The process of claim 1, wherein the titanium oxalate compound is represented by the general formula (Ti₂ₓAₐB_{b}C_{c}D_{d}EₑF_{f})O₃(H₂O)₂(C₂O₄), where A is a monovalent cation; B is divalent cation; C is a trivalent cation; D is a tetravalent cation tetravalent; E is a heptavalent cation; F is a hexavalent cation; 0<x≦1; 0≦b<2; 0≦c<2; 0≦d<2; 0≦e<2; 0≦f<2.

8. The process claim 1, wherein a concentration of the titanium compound in the acidic medium is from about 0.01 M to about 5 M.

9. The process of claim 1, wherein the reacting further comprises controlling a temperature of the acidic medium from about 25° C. to about 200° C.

10. The process of claim 1, wherein the reacting comprises stirring the reaction at a speed sufficient to obtain a pre-determined morphology.

11. The process of claim 1 further comprising:
sintering the titanium oxalate complex to form a titania-based compound;
wherein:
the titania-based compound comprises primary and secondary particles.

12. The process of claim 11, wherein the primary titania-based compound comprises particles from about 1 nm to about 200 nm; and the secondary titania-based compound comprises particles from about 0.5 μm to about 50 μm.

13. The process of claim 11, wherein the sintering comprises heating the titanium oxalate complex to a temperature and for a time sufficient to remove at least some of the carbon and water.

14. The process of claim 13, wherein the temperature is from about 100° C. to about 1000° C.

15. The process of claim 13, wherein the time is from 1 hour to one week.

16. The process of claim 11, wherein a packing density of the titania-based compound is from about 0.5 g/cm³ to about 3.0 g/cm³.

17. The process of claim 11, wherein a specific surface area of the titania-based compound is from about 1 m²/g to about 500 m²/g.

18. The process of claim 11, wherein the titania-based compound comprises brookite titania.

19. The process of claim 11, wherein the titania-based compound comprises lithium.

20. An electrode comprising the titania-based compound prepared by the process of claim 11.
